(19) United States
(12) Patent Application Publication
(10) Pub. No.: US 2002/0074429 A1
(43) Pub. Date: Jun. 20, 2002

(54) Atomiser for fluids

(76) Inventors: Patrick Hettrich, Ingelheim (DE); Peter Asp, Biberach (DE)

Correspondence Address: BOEHRINGER INGELHEIM CORPORATION, 900 RIDGEBURY ROAD, P. O. BOX 368, RIDGEFIELD, CT, 06877, US

(21) Appl. No.: 10/001,527

(22) Filed: Oct. 24, 2001

(30) Foreign Application Priority Data
Oct. 28, 2000 (DE) 200 18 518.7

(51) Int. Cl. B05B 9/043

(52) U.S. Cl. 239/333

(57) ABSTRACT

The present invention relates to a new atomizer for nasal or oral application of a medicinal-pharmaceutical aerosol, wherein the active ingredient formulation is always kept under sterile conditions. It is preferred that moisturizers, medicaments and/or wound healing agents are sprayed from the atomizer into the nose or the mouth.

The present invention relates to a new atomiser for atomising a pharmaceutical fluid for application of a medicinal-pharmaceutical aerosol, wherein the active ingredient formulation is always kept under sterile conditions. The thus-created aerosols can be applied, for example, nasally, orally, via the ears or onto the skin. Nasal application is preferred. Moisturisers, medicaments and/or wound healing agents can be applied via the atomiser.

With nasal sprays of the hereinbefore-described type—that is, nasal sprays for continuous and repeated use—it is necessary on the one hand for the atomiser to possess a relatively large reservoir of active ingredients, and on the other hand not to be too heavy, so that the spray is not used up too quickly and at the same time the user can always carry the nasal spray with them.

Most known nasal sprays comprise a pump attachment and a glass storage container. Such atomisers have the disadvantage that the net weight, i.e. the weight without the active ingredient formulation, is already relatively heavy. Making larger quantities of active ingredient formulation available in such atomisers, in part produced from glass, correspondingly leads to comparatively very heavy devices which are unwieldy and uncomfortable for the user. Furthermore, glass is relatively easily broken, which does not only require increased attentiveness from the user and which in particular can very strongly restrict useability by children, but this fragility also often causes problems in manufacturing, storage and distribution. For example, the storage container can easily be broken when it is filled or when the pump attachment is attached to the bottle neck. A further source of danger is the labelling and packaging of such a glass bottle. Naturally, transportation and distribution also represent further risks with regard to the fragility of the bottle.

In other nasal sprays, the storage containers comprise plastic bottles. However, these have the disadvantage that they are not flavour-neutral and are not gas impermeable. Hence oxygen can easily diffuse into the storage container and lead to oxidation of the active ingredient components.

Finally, there are other atomisers wherein the active ingredient formulation is always kept at an overpressure in comparison to the outside environment. On the one hand, such an overpressure is used to propel the active ingredient formulation through the nozzle in the attachment and hence to create the aerosol. The use of pump assemblies can be dispensed with in such cases. On the other hand, the overpressure means that no material can enter into the storage container from outside and hence lead to contamination of the active ingredient formulation. When the attachment of such a device is a pump attachment for manual production of the aerosol by means of pumping, this has the disadvantage that the active ingredient formulation can also flow out from the valve in the attachment when in its position of rest, and in part precipitates or condenses on the valve where it is microbiologically contaminated. At the same time, it is possible for active ingredient formulation to precipitate on the outlet valve during spraying, or for small quantities of water to condense there. Both lead to unsterile fluid precipitating on the outlet valve and the nozzle and being sprayed into the nose of the user when the atomiser is next used.

Hence the object of the present invention is to provide an atomiser which overcomes the difficulties known from the prior art.

The object is solved in that an atomiser is provided which comprises an aluminium storage container and a pump attachment which allows manual atomisation by means of a pump movement and sterilises inflowing air to equalise pressure in the storage container. Here, the active ingredient formulation is always under normal pressure, an overpressure is not required.

Within the framework of the present invention, the pump attachment must have the following features:

a snap or crimp closure for fixing onto the storage container;

a pump channel which can pump fluid from the storage container into a pressure chamber;

a valve which is provided between the storage vessel and the pressure chamber;

a riser which leads from the pressure chamber to a nozzle;

a pressure control valve which is connected to the riser and which is preferably provided within the riser;

a nozzle to atomise the fluid;

a triggering element via which a piston can be operated to produce the pressure necessary for atomisation in the pressure chamber;

air inlet points outside of the pump tube or the riser and air inlet paths from outside the pump attachment extending into the storage container;

oligodynamically-effective substances in and/or along the paths taken by the fluid in the pump channel and/or riser between the storage container and the nozzle;

sterilisation means along the path taken by the inflowing air, i.e. between the air inlet openings and the storage container.

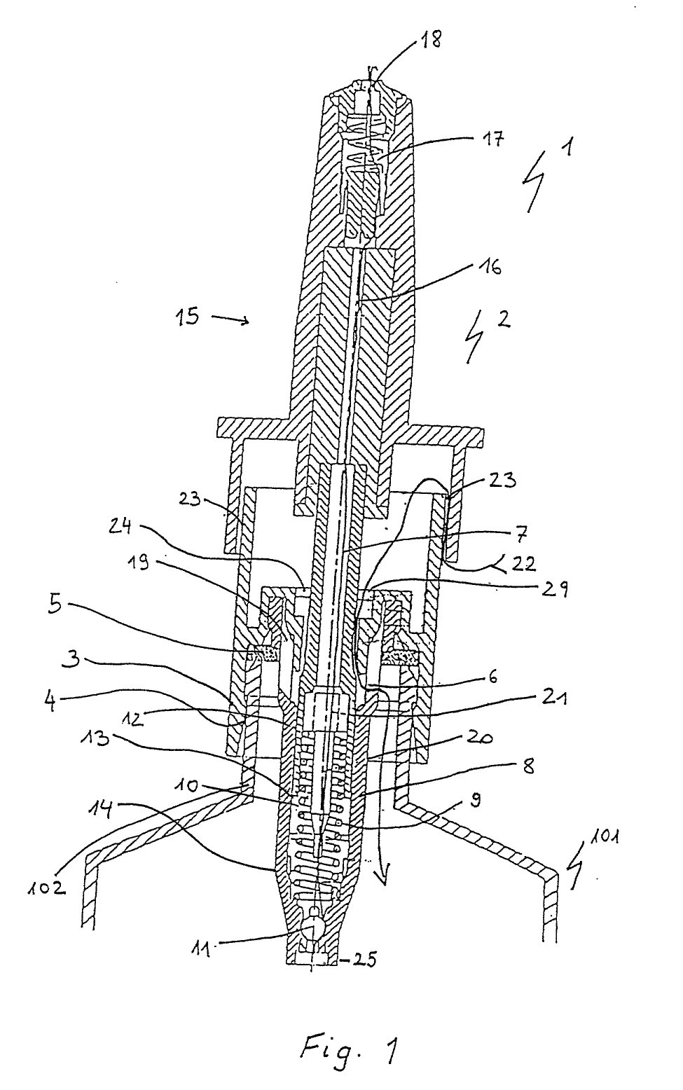

The pump attachment is preferably one such as is for example described in WO 97/18902 and shown in FIG. 1. The pump attachment (2) is firmly fixed to the bottle neck (102) via the snap closure (3). Here, the inner edge of the snap closure (4) is pushed over the bead-shaped edge (105) of the bottle neck (102). A seal (5) is disposed between the bottle neck and the pump attachment, this seal being formed from e.g. rubber, natural or synthetic caoutchouc or preferably from polyethylene. Fluid can be pumped from the storage container into the pressure chamber (10) via a first pumping channel (25). The pressure chamber (10) can be configured as a part of the first pumping channel (25) in its upper area. A ball valve (11) closes the path of the fluid through the first pumping channel (25) into the pressure chamber (10). The pressure chamber (10) is a part of the pressure cylinder (8). A piston (6) is disposed in the pressure cylinder (8) with a further axial pumping channel (7). The piston (6) is held against a detent in its upper rest position by the spring (9). The pressure chamber (10) is disposed between the piston (6) and the ball valve (11) and is connected with the upper pumping channel (7).

The piston (6) has a smaller external diameter than the internal diameter of the pressure cylinder (8), leaving a gap (12) between the external wall of the piston and the internal wall of the cylinder which is sealed by the peripheral sealing body (13) of the piston. In the lower area of the pressure chamber (10), the pressure cylinder (8) has an area (14) with a larger internal diameter in which the sealing body (13) has no sealing effect.

A triggering element (15) is disposed on the piston (6) with the upper pumping channel (7). From here, a riser (16), which is connected to a pressure control valve (17), leads to a nozzle (18) in order to bring the fluid which is to be atomised through the opening of the nozzle. According to the function, the upper pumping channel (7) and the riser (16) form a common riser which connects the pressure chamber to the nozzle.

The pressure control valve (17) is connected to the riser (16) in such a way that the fluid flows around it, at least in part. The pressure control valve can be disposed at any point within the common riser, which is formed from the upper pumping channel (7) and the riser (16). In FIG. 1, it is provided in the upper area of the riser (16).

If the piston (6) is in its upper position of rest, as shown in the diagram, the sealing body (13) seals the pressure chamber (10) from the opening (19) of the storage container. The pushrod (20) is firmly connected to the piston (6) in the area (21) and has a star-shaped diameter so that a free space is left between the pressure chamber (10) and the upper pumping channel (7).

In the rest position, the pushrod (20) is far removed from the ball valve (11) so that this valve is opened with regard to the storage container when enough underpressure is produced in the pressure chamber (10) and the valve is closed when the pressure there is correspondingly high.

The fluid takes the following path through the pump attachment: firstly it is pumped by the first pumping channel (25) out of the storage container into the pressure chamber (10) via the open ball valve (11) and then enters the pumping channel (7). From there, the fluid passes the riser (16) with the pressure control valve (17) disposed there and finally reaches the nozzle (18).

In order to avoid biological contamination of the fluid in the storage container, oligodynamically-effective substances are disposed along the path taken by the fluid from the storage container to the nozzle.

These substances can, for example, be formed on the spring (9), on the wall of the upper pumping channel (7) or the riser (16), in the pressure control valve (17) and/or on the nozzle (18).

In order to equalise pressure in the storage container (101) after drawing out fluid, air can enter the device from the outside at the points (23) and can then penetrate into the storage container (101), as is shown for example by the arrow (22) in the drawing.

Means for sterilising the incoming air are formed along the airways. These include, for example, sterility filters, membranes which are only air-permeable, bacteria-retaining materials, oligodynamically-effective substances or microbiocidically-effective substances, or combinations thereof. By way of example, a sterility filter (24) is shown in FIG. 1.

As already stated, the pump top fitment (2) is connected to the bottle neck (102) via a snap closure (3).

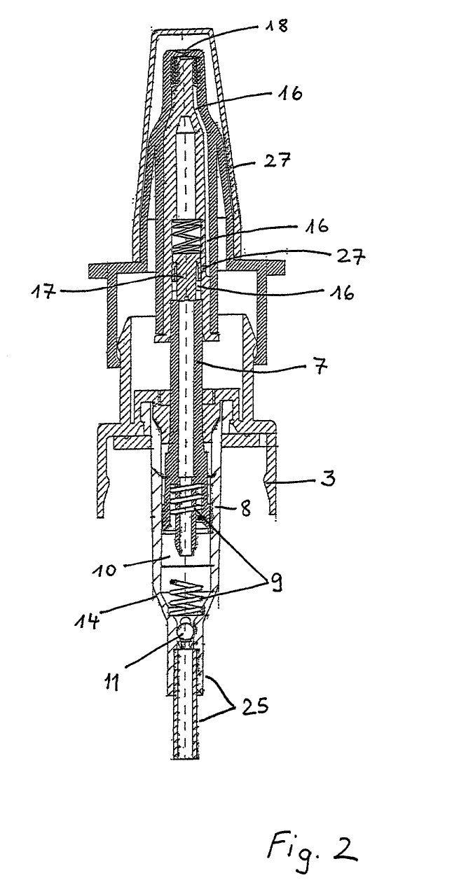

FIG. 2 shows a variant of FIG. 1, wherein the pressure control valve (17) is formed close to the transition area between the upper pump channel (7) and the riser (16). The consequence of this arrangement is that the area of the riser (16) which is disposed between the upper end of the upper pumping channel (7) and the pressure control valve (17) is severely shortened in comparison to that in FIG. 1, whilst the area between the pressure control valve (17) and the opening of the nozzle (18) is clearly lengthened. As soon as the pressure control valve (17) is opened, the opening (26) is released and the fluid can flow from the lower area of the riser (16) which is upstream of the pressure control valve (17), past this valve, through the opening (26) and into the upper area (26) of the riser (16). The nozzle (18) is covered by a push-on cap (27).

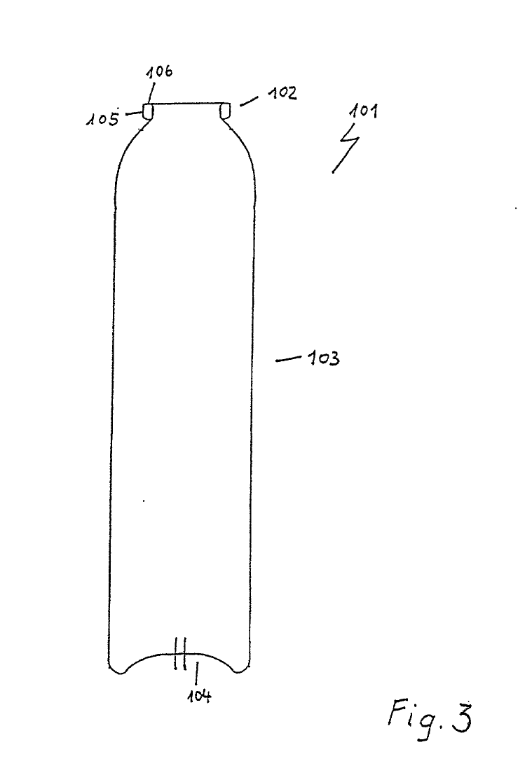

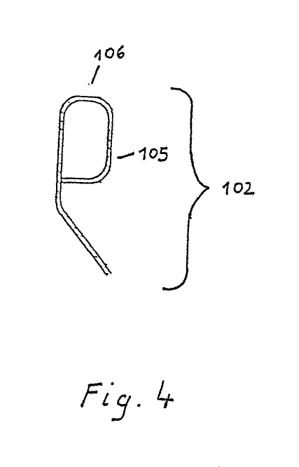

The storage container is an aluminium bottle as shown in FIG. 3. FIG. 4 shows an enlargement of the bottle neck. The storage container (101) comprises the bottle neck (102), the bottle body (103) and the concave bottle base (104). The bottle neck has a beaded shape (105). Viewed in the direction from the bottle body to the bottle opening, a ring-shaped indentation extending perpendicular to the axis is optionally formed at the start of the bottle neck in order to allow a cap to be anchored.

The bottle neck is generally narrower than the bottle body, the external diameter is preferably between 15 and 33 mm, especially preferably 18 to 21 mm. In another embodiment, it is preferably 30 to 33 mm. The internal diameter is preferably 12 to 28 mm, especially preferably between 14 and 16 mm. In another embodiment it is preferably 24-26 mm. The height of the bottle is preferably 50 mm to 250 mm, especially preferably 50 mm to 125 mm, most specially preferably 60 mm-90 mm.

The bottle wall has a thickness of 0.3 to 0.5 mm in the wall and neck area, preferably 0.37 to 0.41 mm. The wall thickness of the base area is 0.5 mm to 1.5 mm, preferably 0.8 to 1 mm.

The outside of the bottle can be varnished or optionally printed, the inside, including the bottle neck and its upper edge (106), can be coated with a synthetic varnish. This is preferably Epoxiphenol. The varnish is advantageous to increase the corrosion resistance of the bottle to the active ingredient formulation and simultaneously to prevent the active ingredient formulation from adopting a metallic flavour.

In a preferred embodiment, the upper edge (106) of the bottle neck is rolled flat or in a form. This enhances the seal between the bottle neck and the pump attachment seal.

The advantages of the atomiser according to the invention are to be found:

in the relatively low inherent weight of the device itself in comparison to the filled atomiser,

in the unbreakableness of the storage container, which is of especially great significance during attachment of the pump attachment to the bottle neck,

in that the active ingredient formulation does not undergo a change in taste as a result of the storage container material,

in that the storage container is not gas-permeable, so the pharmaceutical stability of the active ingredient formulation is not reduced by gases diffusing in, even over longer storage periods,

in that the storage container is opaque.

What is claimed is:

1. An atomiser for atomising a sterile, pharmaceutical fluid, which fluid is not under pressure, comprising
a) an aluminium storage container in the shape of a bottle (101) for the fluid, wherein the storage container has a beading (105) on the upper end of the bottle neck (102) and a flat or form-rolled upper edge and
b) a pump attachment (2), fitted permanently to the neck of the storage container, for manual atomisation of the fluid by pumping, wherein the pump attachment has the following features:
a snap or crimp closure (3) for fixing onto the storage container (101);
a pump channel (25) which can pump fluid from the storage container into a pressure chamber;
a valve (11) which is provided between the storage vessel and the pressure chamber;
a riser (7, 16) which leads from the pressure chamber (10) to a nozzle (18);
a pressure control valve (17) which is connected to the riser;
a nozzle (18) to atomise the fluid;
a triggering element (15) via which a piston (6) can be operated to produce the pressure necessary for atomisation in the pressure chamber (10);
air inlet points (23) outside of the riser (7, 16) and air inlet paths (22) extending from outside the pump attachment into the storage container;
oligodynamically-effective substances in and/or along the paths taken by the fluid in the pump channel and/or riser between the storage container and the nozzle;
sterilisation means (24) along the path taken by the inflowing air, i.e. between the air inlet openings and the storage container.

2. An atomiser according to claim 1, characterised in that the external diameter of the bottle neck is between 15 and 33 mm, preferably 18 to 21 mm or 30 to 33 mm.

3. An atomiser according to claim 1, characterised in that the internal diameter of the bottle neck is 12 to 28 mm, preferably 14 to 16 mm or 24 to 26 mm.

4. An atomiser according to claim 1, characterised in that the wall of the storage container has a thickness in the wall and neck area of 0.3 to 0.5 mm, preferably 0.37 to 0.41 mm, and has a thickness in the base area of 0.5 to 1.5 mm, preferably 0.8 to 1 mm.

5. An atomiser according to claim 1, characterised in that the bottle neck has an annular indentation extending perpendicular to the axis.

6. An atomiser according to claim 1, characterised in that the storage container, including the neck and the upper edge of the neck, are varnished on the inside.

7. An atomiser according to claim 1, characterised in that the upper edge of the storage container is finely ground flat.

8. An atomiser according to claim 1, characterised in that a seal made from rubber or natural or synthetic caoutchouc, or polyethylene, is disposed between the bottle neck and the pump attachment.

9. An atomiser according to claim 1, characterised in that the bottle height is about 50 to about 250 mm.

10. An atomiser according to claim 9, characterised in that the bottle height is about 50 to about 125 mm.

11. An atomiser according to claim 10, characterised in that the bottle height is about 60 to 90 mm.
